(19) United States
(12) Patent Application Publication
(10) Pub. No.: US 2025/0298353 A1
(43) Pub. Date: Sep. 25, 2025

(54) IMAGE FORMING APPARATUS

(71) Applicant: CANON KABUSHIKI KAISHA, Tokyo (JP)

(72) Inventor: TAKUYA UEMURA, Chiba (JP)

(21) Appl. No.: 19/061,217

(22) Filed: Feb. 24, 2025

(30) Foreign Application Priority Data
Mar. 25, 2024 (JP) 2024-047847

(51) Int. Cl. G03G 15/00

(52) U.S. Cl. CPC G03G 15/5016

(57) ABSTRACT

Disclosed is an image forming apparatus for forming an image on a recording material, including a main body having an image forming portion that forms an image on a recording material; and an operation portion that has a display portion that displays information on image forming and a notification portion that notifies a state of the image forming apparatus, the operation portion being slidably provided in the main body between a first position where the entirety of the display portion is exposed from the apparatus main body and a second position where the display portion is stored in the main body such that at least a part of the display portion is invisible from outside the main body. The notification portion is provided in a position where the notification portion is visible from outside the main body when the operation portion is in the second position.

### BACKGROUND OF THE INVENTION

### Field of the Invention

This invention relates to an image forming apparatus with an operation panel.

### Description of the Related Art

An image forming apparatus for forming an image on a recording material is provided with an operation panel including a display for displaying information on progression state of image formation or various setting content. These days, there is a tendency for such an image forming apparatus of having a larger operation display for improving the visibility of the display and for increasing the amount of information to be displayed.

The Japanese Patent Application Laid-Open No. 2021-53818 discloses an image forming apparatus whose screen can be enlarged when a larger screen is necessary by accommodating a part of a flexible display with a touch panel on the surface in an accommodating portion and by drawing out the display from the accommodating portion as needed. Further, Japanese Patent Application Laid-Open No. 2018-12224 discloses an image forming apparatus provided with a display device including an light emitting portion that emits light with a predetermined color to display the state of the image forming apparatus.

However, when the light emitting portion disclosed in Japanese Patent Application Laid-Open No. 2018-12224 is provided on the operation panel accommodated in the accommodating portion disclosed in Japanese Patent Application Laid-Open No. 2021-53818, enough notification performance for a user cannot be obtained depending on the disposition of the operation panel. In particular, when the light emitting portion is provided in the part of the operation panel that is accommodated in the accommodating portion, there is a problem that the notification performance decreases greatly when the operation panel is accommodated in the accommodating portion.

### SUMMARY OF THE INVENTION

An image forming apparatus according to the present invention for forming an image on a recording material, comprises:
an apparatus main body having an image forming portion that forms an image on a recording material; and
an operation portion that has a display portion that displays information on image forming and a notification portion that notifies a state of the image forming apparatus, the operation portion being slidably provided in the apparatus main body between a first position where the entirety of the display portion is exposed from the apparatus main body and a second position where the display portion is stored in the apparatus main body such that at least a part of the display portion is invisible from outside the apparatus main body,
wherein the notification portion is provided in a position where the notification portion is visible from outside the apparatus main body when the operation portion is in the second position.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to the first embodiment of the present invention.

FIG. 2 is a diagram showing a perspective view of the image forming apparatus according to the first embodiment of the present invention in the state where an operation panel is stored.

FIG. 3 is a diagram showing a perspective view of the operation panel of the image forming apparatus according to the first embodiment of the present invention.

FIG. 4 is a diagram showing a perspective view of the image forming apparatus according to the first embodiment of the present invention in the state where the operation panel is exposed and before the operation panel is rotated.

FIG. 5 is a diagram showing a perspective view of the image forming apparatus according to the first embodiment of the present invention in the state where the operation panel is exposed and after the operation panel is rotated.

FIG. 6 is a block diagram showing the configuration of the image forming system including the image forming apparatus according to the first embodiment of the present invention.

FIG. 7 is a block diagram showing the configuration of the operation panel of the image forming apparatus according to the first embodiment of the present invention.

FIGS. 8A, 8B and 8C are diagrams showing the operation of the operation panel of the image forming apparatus according to the first embodiment of the present invention.

FIG. 9 is a flowchart of panel state detection process performed by the image forming apparatus according to the first embodiment of the present invention.

FIG. 10 is a flowchart of light amount adjustment process performed by the image forming apparatus according to the first embodiment of the present invention.

FIG. 11 is a block diagram showing the configuration of the image forming system including the image forming apparatus according to the second embodiment of the present invention.

FIG. 12 is a diagram showing a perspective view of a part of the image forming apparatus according to the second embodiment of the present invention.

FIG. 13 is a flowchart of the lamp interlocking process performed by the image forming apparatus according to the second embodiment of the present invention.

### DESCRIPTION OF THE EMBODIMENTS

In the following, embodiments of the present invention will be described with reference to the figures.

### First Embodiment

### <Configuration of Image Forming System>

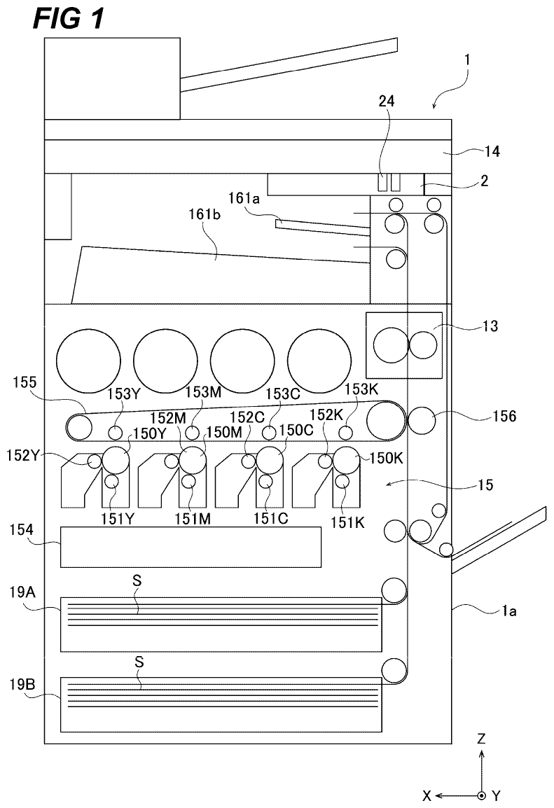

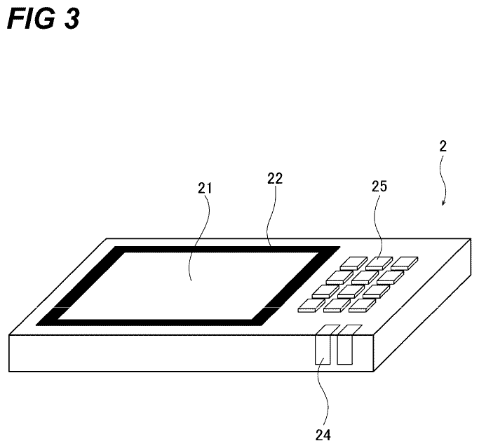

The configuration of the image forming system A1 according to the first embodiment of the present invention will be described in detail with reference to FIGS. 1 to 6.

The image forming system A1 has the image forming apparatus 1 and the processing device 16.

The image forming apparatus 1 forms an image on the sheet S as a recording material and conveys the sheet S on which an image has been formed to the processing device 16 or discharges it outside the image forming apparatus 1. The image forming apparatus 1 discharge the sheet S conveyed by the processing device 16 outside the image forming apparatus 1. Detailed configuration of the image forming apparatus 1 will be described later.

The processing device 16 is exemplified as a finisher connected to the image forming apparatus 1 to expand the function of the image forming apparatus 1 as an option. The processing device 16 performs processes designated by a user such as a staple process, a punch process and a bookbinding process for the sheets S on which images has been formed and which are conveyed by the image forming apparatus 1. The processing device 16 conveys to the image forming apparatus 1 the sheets S for which the processes a user has designated have been performed.

### <Configuration of Image Forming Apparatus>

The configuration of the image forming apparatus 1 according to the first embodiment of the present invention will be described in detail with reference to FIGS. 1 to 6.

The image forming apparatus 1 has the apparatus main body 1a, the operation panel 2, the controller 10, the storage device 11, the power supply device 12, the fixing portion 13, the reader 14, the image forming portion 15, the sheet cassette 19A, the sheet cassette 19B, the detection sensor 30, the detection sensor 31, the discharge tray 161a, the discharge tray 161b, and a main body power switch (not shown) of seesaw or tactile type for switching on/off of the main power.

The apparatus main body 1a has the fixing portion 13, the image forming portion 15, the sheet cassette 19A and the sheet cassette 19B.

The operation panel 2 as an operation portion is provided in the apparatus main body 1a of the image forming apparatus 1 such that the operation panel 2 can be stored in the space under the reader 14. The operation panel 2 is provided such that the operation panel 2 can be moved with respect to the apparatus main body 1a in the direction Y or the direction opposite to the direction Y and further, in the state in which the operation panel 2 has been moved in the direction Y, the operation panel 2 can be rotated around a rotation axis parallel with the direction X. The operation panel 2 works under the control of the controller 10. The detailed configuration of the operation portion 2 will be described later.

The controller 10 controls the overall operation of the image forming apparatus 1, the operation of the processing device 16 and the operation of the notification device 17. The controller 10 is provided with the CPU 100, the memory 101, and the timer 102.

The CPU 100 controls the operations of the operation panel 2, the power supply device 12, the fixing portion 13, the reader 14, the image forming portion 15 and the processing device 16, connected to the controller 10. The CPU 100 reads out the program 110 stored in the storage device 11 and executes it to control the reader 14, the image forming portion 15 and the processing device 16 while using the memory 101 as a working area. The CPU 100 performs image processing for image data input from the reader 14, stores the image data for which the image processing has been performed into the storage device 11, and transfer the image data to the image forming portion 15 where the image forming process is performed in which an image is formed on the sheet S.

The CPU 100 outputs to the operation panel 2 a control signal for controlling the operation of the operation panel 2. The CPU 100 reads out the display image data stored in the storage device 11 and outputs the data to the operation panel 2 to display the image on the operation panel 2.

The CPU 100 controls the operation of the image forming apparatus 1 based on the calculation result of coordinates of the touch position on the touch panel 22 (described later) of the operation panel 2 indicated by an electrical signal input from the operation panel 2. The CPU 100 performs the mode shift operation (described later) based on the count value counted by the timer 102. In the mode shift operation, the image forming apparatus 1 shifts from the stand-by mode to the sleep mode in which less power is consumed.

The CPU 100 performs a panel state detection process (described later) for judging the state of the operation panel 2 based on an electrical signal input from the detection sensors 30 and 31 to perform a light amount adjustment process (described later). When the CPU 100 changes the light amount of the state display portion 24 in the light amount adjustment process, the CPU 100 generates a control signal (command) for changing the light amount of the state display portion 24 and outputs the generated control signal to the operation panel 2.

In the memory 101, the data required when the CPU 100 executes the program 110 are temporarily stored.

The timer 102 times by counting the counting value under the control of CPU 100 when the CPU performs various processes.

In the storage device 11, stored are the various programs 110 relating to the control of the image forming apparatus 1, the display image data, and the printing data. The various programs 110 stored in the storage device 11 include a software group for functioning for the controller 10 to perform the various processes. The display image data stored in the storage device 11 are ones for displaying an image on the operation panel 2.

The power supply device 12 receives electric power via an outlet (not shown) from the commercial power line. The power supply device 12 supplies the electric power supplied from the commercial power line to the respective devices of the image forming system A1 under the control of the CPU 100.

The fixing portion 13 fixes the toner image on the sheet S by applying heat and pressure to the sheet S on which the toner image has been secondarily transferred that is conveyed by the intermediate transfer belt 155 and the secondary transfer roller 156. The fixing portion 13 conveys the sheet S on which the toner image has been fixed to the discharge tray 161a or the discharge tray 161b.

The reader 14 optically reads the image of a document placed on a glace surface (not shown), converts it into image data, and outputs the converted image data to the image forming portion 15.

The image forming portion 15 performs the image forming process for forming an image on the sheet S fed by the sheet cassette 19A or the sheet cassette 19B based on the image data input by the reader 14. The image forming portion 15 has the photosensitive drums 150Y, 150M, 150C and 150K, the charging devices 151Y, 151M, 151C and 151K, the developing devices 152Y, 152M, 152C and 152K, the primary transfer rollers 153Y, 153M, 153C and 153K, the laser scanner unit 154, the intermediate transfer belt 155, and the secondary transfer roller 156.

The photosensitive drums 150Y, 150M, 150C and 150K are driven to rotate by a driving device (not shown). A toner image is formed on the photosensitive drums 150Y, 150M, 150C and 150K by the charging devices 151Y, 151M, 151C and 151K, the developing devices 152Y, 152M, 152C and 152K, and the laser scanner unit 154,

The charging devices 151Y, 151M, 151C and 151K respectively charge the surfaces of the photosensitive drums 150Y, 150M, 150C and 150K.

The developing device 152Y forms a yellow toner image on the photosensitive drum 150Y by attaching yellow toner to an electrostatic latent image formed on the surface of the photosensitive drum 150Y by the laser scanner unit 154.

The developing device 152M forms a magenta toner image on the photosensitive drum 150M by attaching magenta toner to an electrostatic latent image formed on the surface of the photosensitive drum 150M by the laser scanner unit 154.

The developing device 152C forms a cyan toner image on the photosensitive drum 150C by attaching cyan toner to an electrostatic latent image formed on the surface of the photosensitive drum 150C by the laser scanner unit 154.

The developing device 152K forms a black toner image on the photosensitive drum 150K by attaching black toner to an electrostatic latent image formed on the surface of the photosensitive drum 150K by the laser scanner unit 154.

By the primary transfer bias being applied, the primary transfer roller 153Y primarily transfers the yellow toner image formed on the surface of the photosensitive drum 150Y by the developing device 152Y onto the intermediate transfer belt 155.

By the primary transfer bias being applied, the primary transfer roller 153M primarily transfers the magenta toner image formed on the surface of the photosensitive drum 150M by the developing device 152M onto the intermediate transfer belt 155 such that the magenta toner image is superimposed on the yellow toner image formed on the intermediate transfer belt 155.

By the primary transfer bias being applied, the primary transfer roller 153C primarily transfers the cyan toner image formed on the surface of the photosensitive drum 150C by the developing device 152C onto the intermediate transfer belt 155 such that the cyan toner image is superimposed on the yellow toner image and magenta toner image formed on the intermediate transfer belt 155.

By the primary transfer bias being applied, the primary transfer roller 153K primarily transfers the black toner image formed on the surface of the photosensitive drum 150K by the developing device 152K onto the intermediate transfer belt 155 such that the black toner image is superimposed on the yellow toner image, the magenta toner image and cyan toner image formed on the intermediate transfer belt 155.

The image data output from the reader 14 or the image data transmitted from an external device (not shown) via network and received is input to the laser scanner unit 154. The laser scanner unit 154 eradicates the surfaces of the photosensitive drums 150Y, 150M, 150C and 150K charged by the charging devices 151Y, 151M, 151C and 151K with a laser beam according to the input image data to form electrostatic latent images on the surfaces of the photosensitive drums 150Y, 150M, 150C and 150K.

A full-color toner image is formed on the intermediate transfer belt 155 by the respective toner images being superimposed by the primary transfer rollers 153Y, 153M, 153C and 153K and being primarily transferred.

The secondary transfer roller 156 forms a secondary transfer portion along with the intermediate transfer belt 155. By a secondary transfer bias being applied, in the secondary transfer portion, the secondary transfer roller 156 secondarily transfer the full-color toner image on the intermediate transfer belt 155 onto the sheet S fed from the sheet cassette 19A or the sheet cassette 19B. The secondary transfer roller 156 conveys the sheet S on which the full-color toner image has been secondarily transferred to the fixing portion 13 along with the intermediate transfer belt 155.

In the sheet cassette 19A, sheets S are accommodated.

In the sheet cassette 19A, sheets S are accommodated.

The detection sensor 30 is provided under the reader 14. The detection sensor 30 is a photosensor of photo-interrupter type having a light emitting portion (not shown) that emits light and a light receiving portion (not shown) that receives the light emitted from the light emitting portion. The detection sensor 30 detects the light blocking member 71 that moves together with the operation panel 2 and the shaft portion 62 and outputs an electrical signal according to a detection result to the controller 10.

The detection sensor 31 is provided under the reader 14. The detection sensor 31 is a photosensor of photo-interrupter type having a light emitting portion (not shown) that emits light and a light receiving portion (not shown) that receives the light emitted from the light emitting portion. The detection sensor 31 is provided in a position deferent from the one in which the detection sensor 30 is provided in the direction Y that is a moving direction in which the operation panel 2 moves. The detection sensor 31 detects the light blocking member 71 that moves together with the operation panel 2 and the shaft portion 62 and outputs an electrical signal according to a detection result to the controller 10.

The sheet S on which a conveyed toner image has been fixed by the fixing portion 13 is discharged via the processing device 16 onto the discharge tray 161a or is discharged as it is not via the processing device 16 onto the discharge tray 161a.

The sheet S on which a conveyed toner image has been fixed by the fixing portion 13 is discharged via the processing device 16 onto the discharge tray 161b or is discharged as it is not via the processing device 16 onto the discharge tray 161b.

### <Configuration of Operation Panel>

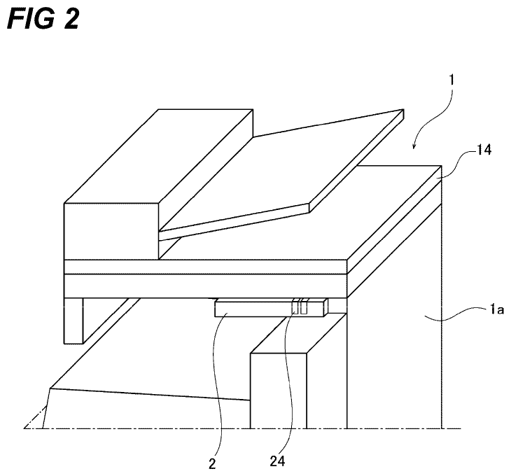

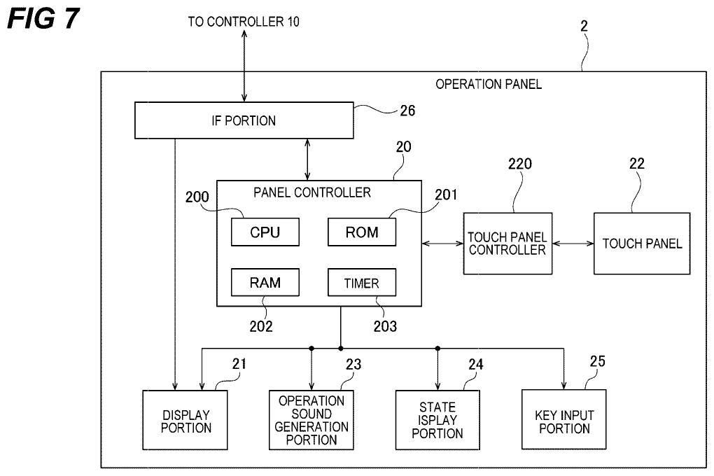

The configuration of the operation panel 2 of the image forming apparatus 1 according to the first embodiment of the present invention will be described with reference to FIGS. 2 to 7.

The operation panel 2 has the panel controller 20, the display portion 21, the touch panel 22, the operation sound generating portion 23, the state display portion 24, the key input portion 25, the IF portion 26, and the touch panel controller 220.

The panel controller 20 controls the overall operation of the operation panel 2 by exchanging an electrical signal with controller 10 via the IF portion 26. The panel controller 20 is provided with the CPU 200, the ROM 201, the RAM 202, and the timer 203.

The CPU 200 executes the control program stored in the ROM 201 according to the control signal input via the IF portion 26 from the CPU 100 to perform various arithmetic processes. By executing the control program, the CPU 200 controls the operations of the display portion 21, the operation sound generating portion 23, the state display portion 24, the key input portion 25, the IF portion 26 and the touch panel portion 220.

The CPU 200 switches between the image of the image data previously stored in the ROM 201 and the image of the display image data input from the CPU 100 via the IF portion 26 for the display portion 21 to display it. The CPU 200 calculates the coordinates of the touch position on the touch panel 22 based on the coordinate data input from the touch panel controller 220 and outputs an electrical signal according to the calculation result of the coordinates of the touch position to the CPU 100 via the IF portion 26.

The CPU 200 changes the lighting state of the state display portion 24 based on the control signal input from the CPU 100 via the IF portion 26. Specifically, the CPU 200 can adjust the light amount of the state of the display portion 24 based on the control signal input from the CPU 100 via the IF portion 26 and controls the lighting state of the display portion 24 such that the display portion 24 emits light with a first light amount or a second light amount greater than the first light amount.

In the ROM 201, various programs such as a control program in relation to the control of the operation panel 2 and information and data in relation to the connection with the image forming apparatus 1 are stored. The information in relation to the connection includes the information on the fact that the connection with the image forming apparatus 1 has been established and the information obtained from the image forming apparatus 1. The information obtained from the image forming apparatus 1 includes the information on the state of the image forming apparatus 1 such as standby mode, sleep mode, and error detection, and the count information such as number of printed sheets.

The RAM 202 is used as a working area during the arithmetic operation by the CPU 200, where data are temporarily stored.

The timer 203 times and counts the count value when the CPU 200 performs various processes under the control of CPU 200.

The display portion 21 is a liquid panel that displays the image of image data previously stored in the ROM 201 or the image of display image data input from the controller 10 via the IF portion 26 under the control of the CPU 200. The images to be displayed on the display portion 21 include the images of information on the image formation such as the number of sheets on which an image is formed and the sizes of the sheets S on which an image is formed or the images of input keys for setting the values about reading of images such as document sizes. The image of the image data stored in the ROM 201 of the operation panel 2 and the image of the display image data the operation panel 2 receives from the controller 10 are switched and displayed on the display portion 21 under the control of the CPU 200.

The touch panel 22 is disposed on the display portion 21. The touch panel 22 is configured to be visible by the screen of the display portion 21 being transparent.

The touch panel 22 is connected to the panel controller 20 via the touch panel controller 220. The touch panel 22 detects a touch operation by a user for an image displayed on the display portion 21 and outputs an electrical signal according to the detection result to the touch panel controller 220.

The operation sound generating portion 23 generates an operation sound according to the operation for the touch panel 22 under the control of the panel controller 20.

The state display portion 24 as a notification portion is provided with LEDs as a light emitting portion that emits light for notifying the state of the image forming apparatus 1 to a user. As shown in FIG. 2, the state display portion 24 is provided in a position where it is visible from outside in the state where the operation panel 2 is stored in the apparatus main body 1a. The state display portion 24 turns on and turns off the LEDs according to the state of the image forming apparatus 1, and changes the state of emitting light under the control of panel controller 20. The state display portion 24 is provided with LEDs with a plurality of colors including red and green for example and notifies the state of the image forming apparatus 1 by changing the color or the lighting pattern according to the states of the image forming apparatus 1. The states of the image forming apparatus 1 include the state where a job is being performed, the state where an error occurs such as the lack of sheets or the jam.

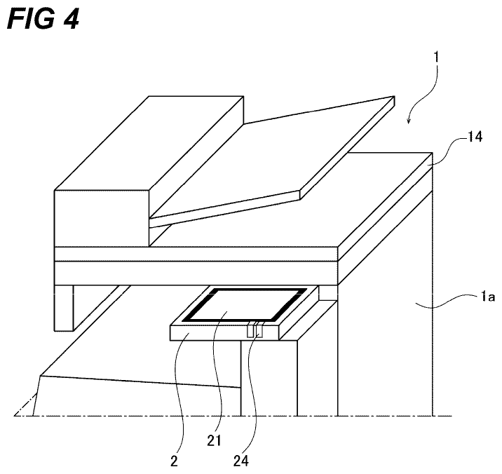

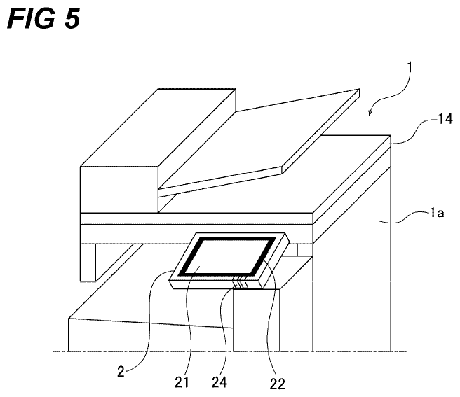

The key input portion 25 is provided on the operation panel 2 at the location outside the display portion 21 and includes hardware keys such as a key for starting the job of image forming apparatus 1, the numeric keys for inputting numerical values, and a key for instructing the shift to the sleep mode. The key input portion 25 receives the setting of image forming apparatus 1 or the input of job instructions by the above keys from a user and outputs an electrical signal according to the received inputs to the panel controller 20. In FIGS. 4 and 5, the key input portion 25 of the operation panel 2 is omitted.

The IF portion 26 exchanges an electrical signal between the CPU 100 of the controller 10 and the CPU 200 of the panel controller 20.

The touch panel controller 220 operates under the control of the panel controller 20. The touch panel controller 220 detects a touch position on the touch panel 22 by a user and outputs to the CPU 200 the coordinate data according to the detected touch position.

The operation panel 2 configured above has both the display portion 21 and the touch panel 22. However, the configuration of the operation panel 2 is not limited to only this one and may have a touch panel display with both the function of the display portion 21 and the function of the touch panel 22.

The operation panel 2 configured above is provided in the apparatus main body 1a such that the operation panel 2 is movable between the stored position in which the operation panel 2 is in the stored state as shown in FIG. 2 and the exposed position in which the operation panel 2 is in exposed state as shown in FIG. 4. Further, as shown in FIG. 5, the operation panel 2 is provided in the apparatus main body 1a such that the operation panel 2 is rotatable around the rotational axis in parallel with the direction X in the exposed state.

The exposed position in which the operation panel 2 is in the exposed state is a first position in which the entire of each of the display portion 21, the touch panel 22, and the key input portion 25 is exposed from the apparatus main body 1a. The stored position in which the operation panel 2 is in the stored state is a second position in which at least a part of each of the display portion 21, the touch panel 22, and the key input portion 25 is stored in the apparatus main body 1a and is invisible from outside. The stored position includes the third position in which the entirety of each of the display portion 21, the touch panel 22, and the key input portion 25 is stored in the apparatus main body 1a and is invisible from outside.

When the operation panel 2 is in the exposed state in which the operation panel 2 is in the exposed position, the entirety of the display portion 21 is visible from outside. Further, when the operation panel 2 is in the exposed state in which the operation panel 2 is in the exposed position, the entirety of the touch panel 22 is in the state of being operational for the touch operation by a user and the entirety of the key input portion 25 is in the state of being operational for the push operation.

When the operation panel 2 is in the stored state in which the operation panel 2 is in the stored position, at least a part of the display portion 21 is invisible from outside, but at least a part of the display portion 21 is visible from outside. Further, when the operation panel 2 is in the stored state in which the operation panel 2 is in the stored position, at least a part of the touch panel 22 is in the state of not being able to be operational by a user and at least a part of the key input portion 25 is in the state of not able to be operational by a user.

When the operation panel 2 is even either in the exposed position or in the stored position, the state display portion 24 is visible from outside the apparatus main body 1a.

### <Operation of Image Forming Apparatus>

The operation of the image forming apparatus 1 according to the first embodiment of the present invention will be described with reference to FIGS. 1 to 6.

When an image forming job is input on the touch panel 22 of the operation panel 2, the controller 10 receives the image forming job from the touch panel 22 via the touch panel controller 220, the panel controller 20, and the IF portion 26 to start the image forming operation.

When the image forming operation starts, the sheet S stored either in the sheet cassette 19A or in the sheet cassette 19B, is sent to the secondary transfer portion formed by the intermediate transfer belt 155 and the secondary transfer roller 156.

In the image forming portion 15, the surface of the photosensitive drum 150Y is charged by the charging device 151Y.

Next, the laser scanner unit 154 irradiates the surface of the photosensitive drum 150Y with a laser beam according to the image data of a document read by the reader 14 or the image data received from the external device (not shown) via a network. As a result of this, an electrostatic latent image is formed on the surface of the photosensitive drum 150.

Next, developing device 152Y attaches yellow toner to the electrostatic latent image formed on the surface of the photosensitive drum 150Y to form a yellow tonner image on the surface of the photosensitive drum 150Y.

Next, the toner image formed on the photosensitive drum 150Y is primarily transferred onto the intermediate transfer belt 155 by the primary transfer roller 153Y.

By the similar process, magenta, cyan, and black toner images are respectively formed on the photosensitive drums 150M, 150C, 150K. By the primary transfer bias being applied to the primary transfer rollers 153M, 153C, and 153K, these toner images are transferred in a superimposed manner on the yellow toner image on the intermediate transfer belt 155. As a result, a full-color toner image is formed on the intermediate transfer belt 155 according the image signal.

The full-color toner image formed on the intermediate transfer belt 155 is conveyed to the secondary transfer portion by the rotation of the intermediate transfer belt 155.

Next, the full-color toner image formed on the intermediate transfer belt 155 and conveyed to the secondary transfer portion is transferred on the sheet S that is conveyed by the sheet cassette 19A or the sheet cassette 19B in the secondary transfer portion.

The sheet S on the a toner image has been transferred is conveyed to the fixing portion where the toner image is fixed by the heating and pressing processes.

The sheets S on which the toner images have been fixed are conveyed to the processing device 16. When a user designates the staple process, the punch process or the bookbinding process, the designated process is performed for the sheets S and the sheets S are discharged on the discharge tray 161a. When a user does not designate the staple process, the punch process or the bookbinding process or when the processing device 16 is not connected, the sheets S are discharged on the discharge tray 161b without these processes being performed.

### <Mode Shift Operation of Image Forming Apparatus>

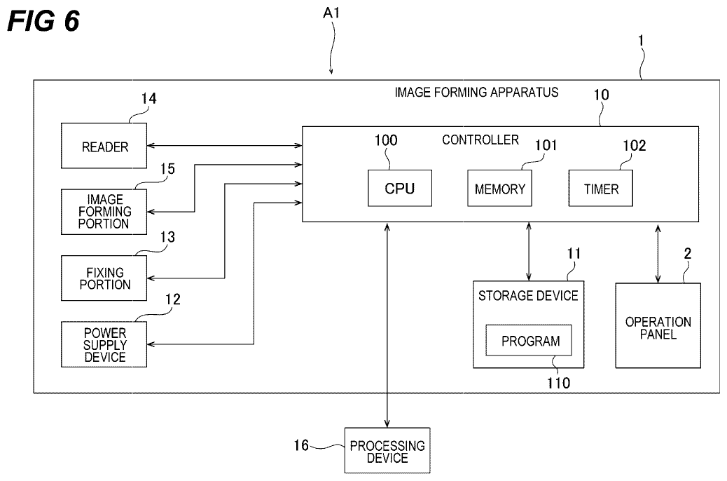

The mode shift operation of the image forming apparatus 1 according to the embodiment of the present invention will be described with reference to FIG. 6.

The CPU 100 is able to perform the stand-by mode and the mode shift operation for shifting to the sleep mode whose power consumption is less than that of the stand-by mode.

In the stand-by mode, the power supply device 12 supplies electric power to the controller 10 and the devices to be used, and does not supply electric power to the devices not to be used under the control of the CPU 100. For example, when a user chooses to read an image, the power supply device 12 supplies electric power to the reader 14 that is the device to be used and does not supply electric power to the image forming portion 15 and the processing device 16 that are the devices not to be used.

When the image forming apparatus 1 has not been used for a certain period of time or when the shift instruction to the sleep mode from a user via the touch panel 22 has been accepted, the CPU 100 performs the mode shift operation that shifts the current mode from the stand-by mode to the sleep mode.

When the current mode shifts from the stand-by mode to the sleep mode, the power supply device 12 stops the supply of electric power to the devices whose electric power has been supplied during the stand-by mode according to the control of the CPU 100.

When the CPU 100 detects an input from a user in the sleep mode, the CPU 100 performs the mode shift operation that returns the sleep mode to the stand-by mode. For example, when the CPU 100 accepts the input of the instruction to return the sleep mode to the stand-by mode from a user on the touch panel 22 in the sleep mode, the CPU 100 performs the mode shift operation to return the sleep mode to the stand-by mode. Even when there is not an input from a user in the sleep mode, but when there is an input of the detection result from the reader 14 that a document is put on the reader 14, the CPU performs the mode shift operation to return the sleep mode to the stand-by mode.

### <State Detection Method of Operation Panel>

The state detection method of the operation panel 2 of the image forming apparatus 1 according to the embodiment of the present invention will be described with reference to FIGS. 2 to 5, 8A to 8C.

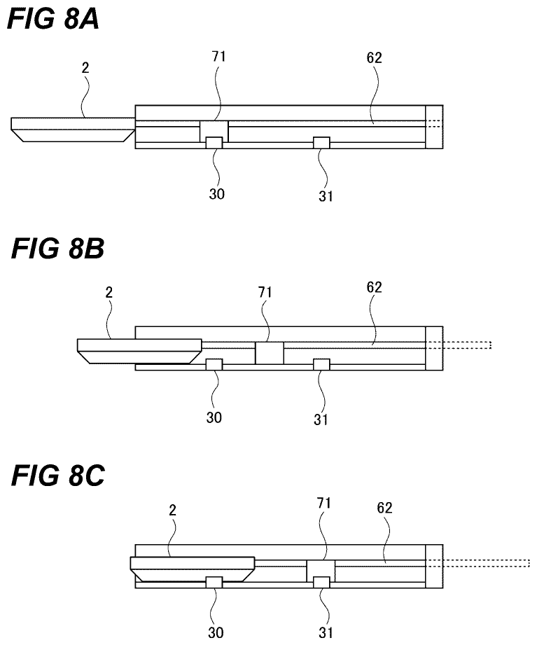

FIG. 8A shows the exposed state in which the operation panel 2 is in the exposed position. FIG. 8B shows the intermediate state in which the operation panel 2 is in the intermediate position between the exposed position and the stored position. FIG. 8C shows the stored state where the operation panel 2 is in the stored position.

In FIGS. 8A, 8B and 8C, the light emitting portions and light receiving portions of the detection sensors 30 and 31 are disposed such that the light emitting portions and light receiving portions are distanced from each other in the direction perpendicular to the sheet surface of FIGS. 8A, 8B and 8C. The light blocking member 71 passes through the space between the light emitting portion and the light receiving portion of the detection sensor 30 and through the space between the light emitting portion and the light receiving portion of the detection sensor 31. Further, the operation panel 2 has a recess (not shown) through which light emitted from the light emitting portion of the detection sensor 30 can reach the light receiving portion of the detection sensor 30 without blocking the light emitted from the light emitting portion of the detection sensor 30 in the state shown in FIG. 8C.

When the operation panel 2 is in the exposed state as the first state (state shown in FIG. 4), the detection sensor 30 detects the light blocking member 71 by the light emitted from the light emitting portion of the detection sensor 30 being blocked by the light blocking member 71 as shown in FIG. 8A. When the operation panel 2 is in the exposed state, the detection sensor 31 does not detect the light blocking member 71 by the light emitted from the light emitting portion of the detection sensor 31 not being blocked by the light blocking member 71 and being received by the light receiving portion of the detection sensor 31 as shown in FIG. 8A. In this case, the CPU 100 judges that the operation panel 2 is in the exposed state according to the detection results of the detection sensor 30 and the detection sensor 31.

When the operation panel 2 is in the intermediate state as a third state, the detection sensor 30 does not detect the light blocking member 71 by the light emitted from the light emitting portion being received by the receiving portion without being blocked by the light blocking member 71 as shown in FIG. 8B. When the operation panel 2 in the intermediate state, the detection sensor 31 does not detect the light blocking member 71 by the light emitted from the light emitting portion of the detection sensor 31 being received by the light receiving portion of the detection sensor 31 without being blocked by the light blocking member 71 as shown in FIG. 8B. In this case, the CPU 100 judges that the operation panel 2 is in the intermediate state according to the detection results of the detection sensor 30 and the detection sensor 31.

When the operation panel 2 is in the stored state as a second state (state shown in FIG. 2), the detection sensor 30 does not detect the light blocking member 71 by the light emitted from the light emitting portion being received by the receiving portion without being blocked by the light blocking member 71 as shown in FIG. 8C. The detection sensor 31 detects the light blocking member 71 by the light emitted from the light emitting portion of the detection sensor 31 being blocked by the light blocking member 71 as shown in FIG. 8C. In this case, the CPU 100 judges that the operation panel 2 is in the stored state according to the detection results of the detection sensor 30 and the detection sensor 31.

The operation panel 2 is configured not to move from the stored position shown in FIG. 8C in the depth direction (rightward direction in FIG. 8C) by a stopper (not shown). A part of the display portion 21 of the operation panel 2 is stored in the apparatus main body 1a in the intermediate state and a part of the part other than the part of the display portion 21 stored in the apparatus main body 1a is exposed outside the apparatus main body 1a.

The detection sensor 30 and the detection sensor 31 are not limited to photosensors and can be configured by mechanical sensors such as switches. The detection and non-detection of the light blocking member 71 by the detection sensor 30 and the detection sensor 31 can be opposite to the above description.

### <Panel State Detection Process>

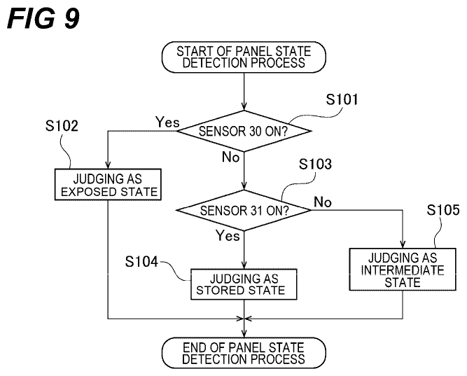

The panel state detection process performed by the image forming apparatus 1 according to the first embodiment of the present invention will be described in detail with reference to FIG. 9.

The panel state detection process shown in FIG. 9 starts at the time when the main power supply of the image forming apparatus 1 is turned on. In FIG. 9, “ON” refers to the fact that the detection sensor 30 or the detection sensor 31 detects the light blocking member 71.

First, the CPU 100 judges whether the detection sensor 30 detects the light blocking member 71 (“ON” or not) based on an electrical signal in response to the detection result input from the detection sensor 30 (step S101).

When the detection sensor 30 detects the light blocking member 71 (step S101: Yes), the CPU 100 judges that the operation panel 2 is in the exposed state (step S102), performs the control for the case in which the operation panel 2 is in the exposed state, and after that, completes the panel state detection process. In this case, the CPU 100 notifies the CPU 200 of the operation panel 2 that the operation panel 2 is in the exposed state by outputting an electrical signal indicating that the operation panel 2 is in the exposed state to the operation panel 2.

In contrast, when the detection sensor 30 does not detect the light blocking member 71 (step S101: No), the CPU 100 judges whether the detection sensor 31 detects the light blocking member 71 (“ON” or not) based on an electrical signal input from the detection sensor 31 (step S103).

When the detection sensor 31 detects the light blocking member 71 (step S103: Yes), the CPU 100 judges that the operation panel 2 is in the stored state (step S104), performs the control for the case in which the operation panel 2 is in the stored state, and after that, completes the panel state detection process. In this case, the CPU 100 notifies the CPU 200 of the operation panel 2 that the operation panel 2 is in the stored state by outputting an electrical signal indicating that the operation panel 2 is in the stored state to the operation panel 2.

In contrast, when the detection sensor 31 does not detect the light blocking member 71 (step S103: No), the CPU 100 judges that the operation panel 2 is in the intermediate state (step S105), performs the control for the case in which the operation panel 2 is in the intermediate state, and after that, completes the panel state detection process. In this case, the CPU 100 notifies the CPU 200 of the operation panel 2 that the operation panel 2 is in the intermediate state by outputting an electrical signal indicating that the operation panel 2 is in the intermediate state to the operation panel 2.

### <Light Amount Adjustment Process>

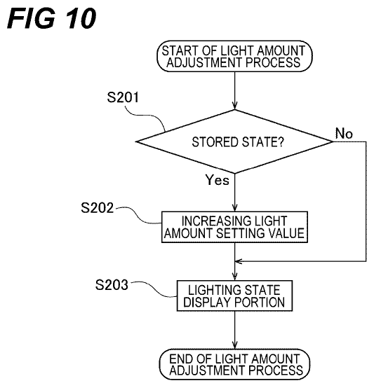

The light amount adjustment process performed by the image forming apparatus 1 according to the first embodiment of the present invention will be described with reference to FIG. 10.

When a user operates the image forming apparatus 1 whose operation panel 2 is in the exposed state, the user's operation can be guided by the operation panel 2. Therefore, the state of the image forming apparatus 1 can surely be notified to the user by the lighting of the state display portion 24 of the operation panel 2.

In contrast, when a user operates the image forming apparatus 1 whose operation panel 2 is in the stored state, the user's operation may not be guided by the operation panel 2. Therefore, the state of the image forming apparatus 1 cannot sufficiently be notified to the user by the lighting of the state display portion 24 of the operation panel 2. Further, when the operation panel 2 is in the stored state, it is harder for the user to visually recognize the lighting of the state display portion 24 as compared with the case where the operation panel 2 is in the exposed state, which may decrease the notifying performance by lighting.

In view of the above problem, the CPU 100 performs the light amount adjustment process shown in FIG. 10 to change the state of lighting of the state display portion 24 in response to a change between the stored state and the exposed state of the operation panel 2.

The light amount adjustment process shown in FIG. 10 starts at the time when the CPU 100 completes the panel state detection process.

First, the CPU 100 judges whether the state of the operation panel 2 that has been judged by performing the panel state detection process shown in FIG. 9 is in the stored state or not (step S201).

When the operation panel 2 is in the stored state (step S201: Yes), the CPU 100 increases the light amount setting value to set the light amount of the state display portion 24 to a larger value than the case where the operation panel 2 is in the exposed state (step S202).

Next, the CPU 100 performs the control to light the state display portion 24 with the light amount set in the step S202 (step S203), and thereafter completes the light amount adjustment process.

In contrast, when the operation panel 2 is in the exposed state or in the intermediate state (step S201: No), the CPU 100 skips the process of the step S202 without changing the setting of light amount of the state display portion 24, and performs the process of the step S203.

In the light amount adjustment process, when the CPU 100 judges that the operation panel 2 is in the exposed state, the CPU 100 outputs to the operation panel 2 a control signal for controlling the state display portion 24 such that the state display portion 24 emits light with a first light amount. Further, when the CPU 100 judges that the operation panel 2 is in the stored state, the CPU 100 outputs to the operation panel 2 a control signal for controlling the state display portion 24 such that the state display portion 24 emits light with a second light amount greater than the first light amount.

When the operation panel 2 is in the third position, the CPU 100 outputs to the operation panel 2 a control signal for the state display portion 24 to emit light with a third light amount greater than the second light amount. Furthermore, when the state display portion 24 emits light with the third light amount in the case where the operation panel 2 is in the third position, the state display portion 24 emits light with the second light amount in the case where the operation panel 2 is in the second position where the operation panel 2 is in the intermediate state.

The exposure amount of the state display portion 24 from the apparatus main body 1a changes in response to the position of the operation panel 2. Further, the less the exposure amount of the operation panel 2 is from the apparatus main body 1a, the greater the light amount of the light emitting portion is.

In the above light amount adjustment process, the light amount of the state display portion 24 in the case where the operation panel 2 is in the exposed state is the same as that in the case where the operation panel 2 is in the intermediate state.

However, the light amount adjustment process is not limited to this and the light amount adjustment process may be configured such that the light amount of the light emitting portion of the state display portion 24 becomes larger when the exposure amount of the operation panel 2 from the apparatus main body 1a becomes smaller based on the fact that the exposure amount of the operation panel 2 from the apparatus main body 1a changes in response to the position of the operation panel 2. With this configuration, the power consumption can be suppressed since the light amount of the light emitting portion of the state display portion 24 becomes smaller when the exposure amount of the operation panel 2 from the apparatus main body 1a becomes larger.

As described above, according to the embodiment of the present invention, the control is performed such that the light amount of the state display portion 24 changes in response of the state of the operation panel 2. Especially in the present embodiment, the light amount of the state display portion 24 is controlled such that the light amount of the state display portion 24 becomes larger in the case where the operation portion 2 is in the stored state than in the case where the operation portion 2 is in the exposed state. With this configuration, the risk can be reduced that the notification performance by the light emission of the state display portion 24 to a user decreases when the operation panel 2 is in the stored state.

In the present embodiment, the operation panel 2 is provided that has the display portion 21 that displays information on the image formation and the state display portion 24 that notifies the state of the image forming apparatus 1. The operation panel 2 is slidably provided in the apparatus main body 1a between the first position where the entirety of the display portion 21 is exposed from the apparatus main body 1a and the second position where the display portion 21 is stored in the apparatus main body 1a such that at least a part of the display portion 21 is invisible from outside the apparatus main body 1a. When the operation panel 2 is in the second position, the state display portion 24 is provided in a position where the state display portion 24 is visible from outside the apparatus main body 1a.

With this configuration, even when it is hard to visually recognize the operation panel 2 when storing the operation panel 2 that can be stored in the apparatus main body 1a in the apparatus main body 1a, it becomes easy for a user to recognize the state of the image forming apparatus 1. Further, the risk can be reduced that the performance of notifying the state of the image forming apparatus 1 to a user decreases.

### Second Embodiment

### <Configuration of Image Forming System>

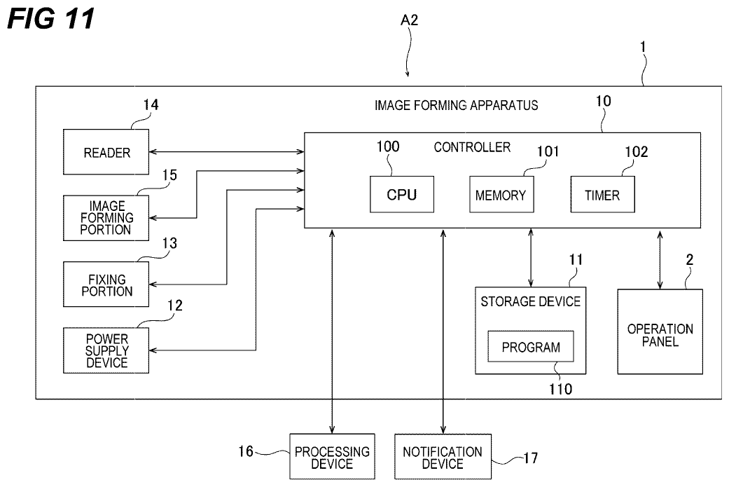

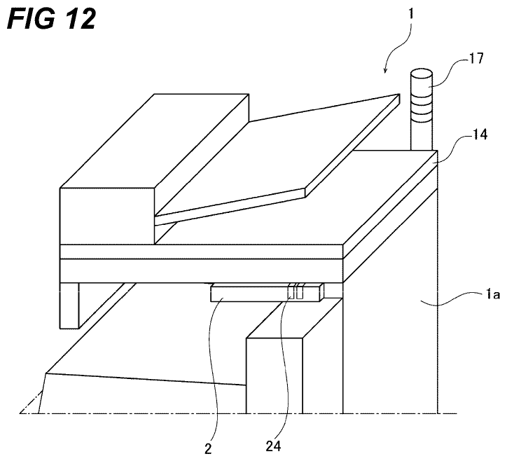

The configuration of the image forming system A2 according to the second embodiment of the present invention will be described in detail with reference to FIGS. 11 and 12.

In FIG. 11, the same reference characters are attached to the same portions as those in FIG. 6 and duplicate descriptions are omitted.

The image forming system A2 has the image forming apparatus 1, the processing device 16, and the notification device 17. Further, the image forming system A2 can be configured without having the process device 16.

With the control of the CPU 100 of the image forming apparatus 1, the notification device 17 notifies the state of the image forming apparatus 1 in response to the state of the operation panel 2.

### <Lamp Interlocking Process>

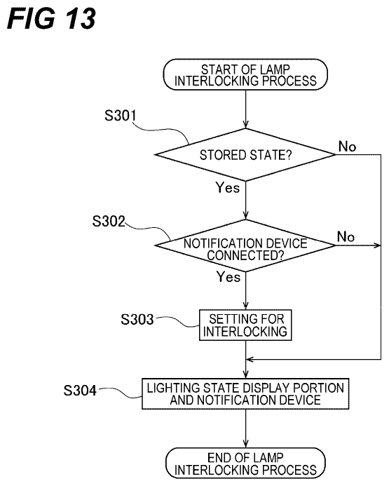

The lamp interlocking process performed by the image forming apparatus 1 according to the second embodiment of the present invention will be described with reference to FIG. 13.

The lamp interlocking process shown in FIG. 13 starts at the time when the CPU 100 completes the panel state detection process.

First, the CPU 100 judges whether the state of the operation panel 2 that was judged by performing the panel state detection process shown in FIG. 9 is the stored state or not (step S301).

When the operation panel 2 is in the stored state (step S301: Yes), the CPU 100 judges whether the notification device 17 is connected to the image forming apparatus 1 (step S302).

When the notification device 17 is connected (step S302: Yes), the CPU 100 sets the state display portion 24 and the notification device 17 to light in an interlocking manner (step S303). Specifically, the CPU 100 performs the control to light the notification device 17 in synchronism with the timing of lighting of the state display portion 24.

Next, the CPU 100 lights the state display portion 24 in response to the state of the operation panel 2 (step S304), thereafter completes the lamp interlocking process.

In contrast, when the operation panel 2 is in the exposed state or in the intermediate state (step S301: No), the CPU 100 skips to the step S304.

Further, when the notification device 17 is not connected (step S302: No), the CPU 100 skips to the step S304.

In the present embodiment, the control of the notification device 17 provided to be always exposed from outside the apparatus main body 1a is performed such that the state of the image forming apparatus 1 is notified in synchronism with the timing of the state display portion 24 notifying the state of the image forming apparatus 1. With this configuration, a decrease in performance of notification of the state of the image forming apparatus 1 to a user can be prevented when the operation panel 2 is in the stored state in addition to the effects of the first embodiment.

The present invention is not limited to the above embodiments and can be varied without departing from the gist thereof.

In the above first and second embodiments, the notification is performed by the state display portion 24 using light. However, the configuration is not limited to this one and a state notification portion may be provided to notify using sound alternative to or in addition to light. In this case, by providing the state notification portion in a position where it is visually recognized from outside, a user clearly hear the sound without being blocked by the apparatus main body 1a, so that a decrease in notification performance can be suppressed.

In the above first and second embodiments, the operation panel 2 is configured to be stored under the reader 14 of the image forming apparatus 1. However, the configuration is not limited to this one. The operation panel 2 may be configured to be bendable, flexible or extendable and contractable.

In the above first and second embodiments, the CPU 100 performs the control based on an electrical signal input from the detection sensor 30 and the detection sensor 31, and the control to change the light amount of the state display portion 24. However, the configuration is not limited to this one and the CPU 200 may perform the control based on an electrical signal input from the detection sensor 30 and the detection sensor 31, and the control to change the light amount of the state display portion 24.

In the above first and second embodiments, the state of the image forming apparatus 1 is notified by the light emitting portion provided on the state display portion 24 emitting light. However, the configuration is not limited to this one and a sound generation portion can be provided as a notification portion that emits sound as an alternative to or in addition to the state display portion 24, so that the state of the image forming apparatus 1 is notified by sound emitted from the sound generation portion. In this case, the volume of the sound emitted from the sound generation portion can be varied. For example, the sound generation portion may be configured to emit sound with the first volume when the operation panel 2 is in the first position and the sound generation portion emits sound with the second volume larger than the first volume when the operation panel 2 is in the second position.

In the case where the sound generation portion is provided in the operation panel 2, the sound emitted by the sound generation portion may be hard to reach the outside of the apparatus when the operation panel 2 is stored in the apparatus main body 1a. Therefore, in the above first and second embodiments, the volume of the sound emitted by the sound generation portion may be changed in response to the store amount of the operation panel 2 to the apparatus main body 1a. Specifically, the apparatus may be configured such that when the exposure amount of the operation panel 2 from the apparatus main body 1a becomes smaller, the volume of the sound emitted from the sound generation portion becomes larger. With this configuration, a user can easily recognize the notification from the state display portion 24.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-47847, filed Mar. 25, 2024, which is hereby incorporated by reference herein in its entirety.

What is claimed is:

1. An image forming apparatus for forming an image on a recording material, comprising:
an apparatus main body having an image forming portion that forms an image on a recording material; and
an operation portion that has a display portion that displays information on image forming and a notification portion that notifies a state of the image forming apparatus, the operation portion being slidably provided in the apparatus main body between a first position where the entirety of the display portion is exposed from the apparatus main body and a second position where the display portion is stored in the apparatus main body such that at least a part of the display portion is invisible from outside the apparatus main body,
wherein the notification portion is provided in a position where the notification portion is visible from outside the apparatus main body when the operation portion is in the second position.

2. The image forming apparatus according to claim 1,
wherein the notification portion has a light emitting portion that emits light, the notification portion being configured to notify the status of the image forming apparatus by the lighting of the light emitting portion.

3. The image forming apparatus according to claim 2,
wherein a light amount of the light emitting portion is adjustable, and
wherein the light emitting portion emits light with a first light amount when the operation portion is in the first position and the light emitting portion emits light with a second light amount larger than the first light amount when the operation portion is in the second position.

4. The image forming apparatus according to claim 3,
wherein the operation portion is movable to the first portion, the second position, and a third position where the operation portion is stored in the apparatus main body such that the entirety of the display portion is invisible from outside.

5. The image forming apparatus according to claim 4,
wherein the light emitting portion emits light with a third light amount larger than the second light amount when the operation portion is in the third position.

6. The image forming apparatus according to claim 1,
wherein the notification portion has a sound generation portion that emits sound, and
wherein the notification portion is configured to notify the state of the image forming apparatus by the sound emitted by the sound generation portion.

7. The image forming apparatus according to claim 6,
wherein a volume of the sound generation portion is adjustable, and
wherein the sound generation portion emits sound with a first volume when the operation portion is in the first position and the sound generation portion emits sound with a second volume larger than the first volume when the operation portion is in the second position.

8. The image forming apparatus according to claim 7,
wherein the operation portion is movable to the first portion, the second position, and a third position where the operation portion is stored in the apparatus main body such that the entirety of the display portion is invisible from outside.

9. The image forming apparatus according to claim 8,
wherein the sound generation portion emits sound with a third volume larger than the second volume when the operation portion is in the third position.

10. The image forming apparatus according to claim 1, further comprising:
a controller that controls a notification device provided to be always exposed outside the apparatus main body such that the state of the image forming apparatus is notified in synchronism with a timing of the notifying portion notifying the state of the image forming apparatus.
